(19) United States
(12) Patent Application Publication
(10) Pub. No.: US 2022/0343806 A1
(43) Pub. Date: Oct. 27, 2022

(54) MODULAR SIGN APPARATUS HAVING INTEGRATED STAKE DRIVER

(71) Applicant: 3MD Inc., Redmond, WA (US)

(72) Inventors: Thomas H. Murphy, Fort Wayne, IN (US); Peter Fischer, Fort Wayne, IN (US)

(21) Appl. No.: 17/239,437

(22) Filed: Apr. 23, 2021

(51) Int. Cl. G09F 7/20

(52) U.S. Cl. CPC G09F 7/20; G09F 2007/1804

(57) ABSTRACT

Technologies and implementations for a modular sign apparatus having an integrated post driver. The technologies and implementations facilitate assembly of a ground engaging sign including a stake driver for a vertical member of the sign apparatus.

Unless otherwise indicated herein, the approaches described in this section are not prior art to the claims in this application and are not admitted to be prior art by inclusion in this section.

A method to advertise real estate property may be to install a sign on the property. For example, the sign may be in the form of a T-shaped sign or an off center cross sign, which may be referred to as a lawn sign (hereon sign). The sign may comprise of two parts, a vertical member and a horizontal member. The vertical member and the horizontal member may be made of square wooden beams to provide strength and support for being outside in the elements (e.g., wind and rain).

Commonly, the two parts of sign may be transported to the property as an assembled unit. Once at the property, one method of placing the sign on the property may involve placing a bottom end of the vertical member of the sign into the ground. This method may involve digging a hole approximate the size of the square wooden beam and placing the bottom end into the ground. Once placed into the ground, earth may be placed in and around the hole to facilitate support of the vertical member in the upright.

Another method of placing the sign onto the property may include using force to place the vertical member of the assembled unit into the ground. For example, one end of the vertical member

All subject matter discussed in this section of this document is not necessarily prior art and may not be presumed to be prior art simply because it is presented in this section. Plus, any reference to any prior art in this description is not and should not be taken as an acknowledgement or any form of suggestion that such prior art forms parts of the common general knowledge in any art in any country. Along these lines, any recognition of problems in the prior art are discussed in this section or associated with such subject matter should not be treated as prior art, unless expressly stated to be prior art. Rather, the discussion of any subject matter in this section should be treated as part of the approach taken towards the particular problem by the inventor(s). This approach in and of itself may also be inventive. Accordingly, the foregoing summary is illustrative only and not intended to be in any way limiting. In addition to the illustrative aspects, embodiments, and features described above, further aspects, embodiments, and features will become apparent by reference to the drawings and the following detailed description.

### SUMMARY

Described herein are various illustrative modular sign systems and methods. Example systems may include modular sign system including a first substantially triangular tube having a top end and a bottom end. The first substantially triangular tube may have a substantially triangular cutout proximate to the top end. The example system may include a second substantially triangular tube having a first end and a second end. The second substantially triangular tube may have an outside dimension to substantially fit within the substantially triangular cutout of the first substantially triangular tube.

Another example modular sign system may include a stake. The stake may have a tubular body, an open end exposing a hole of the tubular body, a ground engaging end opposite the open end, and a number of fins disposed along the length of the tubular body forming a substantially triangular shape. The system may include a first substantially triangular tube having a top end and a bottom end. The first substantially triangular tube may have internal dimensions to substantially match the substantially triangular shape formed by the plurality of fins and may have a substantially triangular cutout proximate to the top end. The system may include a stake driver. The stake driver may have a solid body having a dimension to substantially fit within the open end of the stake. The stake driver may have a weight having a dimension larger than the solid body disposed at one end of the stake driver. The stake driver may have a handle disposed proximate to the weight. The system may include a second substantially triangular tube. The second substantially triangular tube may have a first end and a second end. The second substantially triangular tube may have an outside dimension to substantially fit within the substantially triangular cutout of the first substantially triangular tube.

An example method may include a method of assembling a real estate sign. The method may include causing to dispose a stake into a ground, where the stake may have a tubular body, an open end exposing a hole of the tubular body, a ground engaging end opposite the open end, and a number of fins disposed along the length of the tubular body forming a shape. The example method may include disposing a stake driver into the tubular body of the stake at the open end, the stake driver having a solid body having a dimension to substantially fit within the open end of the stake, a weight having a dimension larger than the solid body disposed at one end of the stake driver, and a handle disposed proximate to the weight. The example method may include causing to slide the stake driver in a substantially up and down motion along the length of the stake. The example method may include sliding a vertical tube along the length of the stake, wherein the plurality of fins are configured to substantially match the shape of the vertical tube.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 illustrates a modular sign system, in accordance with various embodiments;

FIG. 2 illustrates a modular sign system with its components, in accordance with various embodiments; and

FIG. 3 illustrates a stake and stake driver utilized with a modular sign system, in accordance with various embodiments.

### DETAILED DESCRIPTION

The following description sets forth various examples along with specific details to provide a thorough understanding of claimed subject matter. It will be understood by those skilled in the art after review and understanding of the present disclosure, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to apparatus and systems related to a modular sign having integrated vertical support device.

Before turning to the figures, a non-limiting example configurations and utilization of the various embodiments of the present disclosure may be described. In the non-limiting example, a sign may be placed on a property to provide information such as, but not limited to a “For Sale Sign” (hereon sign). The sign may comprise of a first substantially triangular tube (hereon vertical tube), a second substantially triangular tube (hereon horizontal tube), a stake, a stake driver, and a sign panel (e.g., having printed information). In this non-limiting example, the components may be in separate pieces and be transported to the property.

Once at the property, the pointed end of the stake may be slightly pushed into the desired location on the property. The stake driver may be place in the body of the stake drive by being placed into the top end of the stake. The handle of the stake driver may be utilized to drive the stake into the ground using an up and down motion. The stake may be driven into the ground by utilizing a weight, which may be included on handle end of the stake driver. Once the stake has been driven into the ground to a depth to facilitate support for the sign, the stake driver may be removed.

The stake may have a number of fins along the length of the body of the stake. The fins may be disposed along the body to substantially correspond to the internal corners of the vertical tube. For example, the vertical tube may have a cross-sectional shape of an equilateral triangle. Accordingly, the fins may be disposed at 120 degrees relative to each other along the length of the stake to substantially correspond to the internal corners of the vertical tube.

Once the stake has been driven into the ground, the vertical tube may be slid over the stake. Because the fins of the stake may provide support for the vertical tube, the stake may facilitate support for the vertical tube in an upright position. The vertical tube may have a triangular cutout proximate to the top end. The triangular cutout may have dimensions to substantially accommodate the horizontal tube. Accordingly, the horizontal tube may be slid into the cutout to a predetermined length. The predetermined length may be managed by disposing a tab on the body of the horizontal tube to stop the horizontal tube at the desired length. The desired length may accommodate the sign panel (e.g., width of the panel).

The horizontal tube may have various attachment features to facilitate attachment of the panel. For example, the horizontal tube may have hooks to facilitate hanging of the panel. In another example, the horizontal tube may have a channel to facilitate sliding of the panel into the channel.

The vertical tube may have the top end expose (i.e., open tube), and the horizontal tube may have both ends exposed. A number of end caps may be utilized to close the exposed ends of the vertical tube and the horizontal tube.

Continuing with the non-limiting example above, once the sign is no longer needed, the sign may be disassembled. For example, the panel may be removed (e.g., unhung), the horizontal tube may be slid out, the vertical tube may be slid off of the stake in a vertical direction, and the stake may be vertically pulled out. All of the modular components of the sign, including the stake driver, may be transported to the next property, and the module sign system may be assembled again to form the sign.

As a result, the modular sign system may facilitate at least ease of transportation as individual components (e.g., easy breakdown and easy assembly). Additionally, the modular sign system may at least facilitate ease of stake placement (e.g., integrated stake driver, which may facilitate driving in many ground conditions such as, but not limited to soil, sand gravel, wet, dry, frozen, etc.). Further the modular sign system may facilitate improved strength (e.g., the stake configured to support the vertical tube).

In one example, the vertical tube, the horizontal tube, the stake, and the stake driver may comprise of metal type material such as, but not limited to, aluminum, steel, copper, bronze, titanium, platinum, stainless steel, brass, and any combination thereof (e.g., the vertical tube may be aluminum and the horizontal tube may be stainless steel and so forth). In another example, the vertical tube, the horizontal tube, the stake, and the stake driver may comprise of plastic type material such as, but not limited to, polyvinyl chloride, polyethylene, polystyrene, polypropylene, polyrmethyl methacrylate, polyester resin, phenolic resin, organic silicon resin, and any combination thereof (e.g., the vertical tube may be polyvinyl chloride and the horizontal tube may be polyethylene or aluminum and so forth). In yet another example, the vertical tube, the horizontal tube, the stake, and the stake driver may comprise of composite type material such as, but not limited to, fiberglass, carbon fiber, aramid fibers, and any combination thereof (e.g., the vertical tube may be fiberglass and the horizontal tube may be carbon fiber, aluminum, or polyvinyl chloride and so forth). Accordingly, the claimed subject matter is not limited in these respects.

In the example above, the vertical tube and the horizontal tube may have been described as having a substantially triangular shape. However, the shape of the vertical and horizontal tubes may be of a wide variety of shapes such as, but not limited to, substantially square, circular, rectangular, trapezoidal, or any combination thereof. For any one of these examples, the fins on the stake may have a shape to substantially correspond to the internal shape. For the example of a trapezoidal shape, the fins may each facilitate support for each internal corner within the trapezoidal tube. For the example of a circular shape, the fins may have dimensions to substantially correspond to the internal diameter of the circular tube. Accordingly, the claimed subject matter is not limited in these respects.

As a result, the above non-limiting example discloses a modular sign having integrated vertical support device, in accordance with various embodiments. Even though the above non-limiting examples were described with respect to a sign that may be utilized in advertising property (e.g., real estate), the modular sign system described herein may include a wide variety signs, but not limited to, traffic signs, street signs, construction signs, roadwork signs, etc. Accordingly, the claimed subject matter is not limited in this respect.

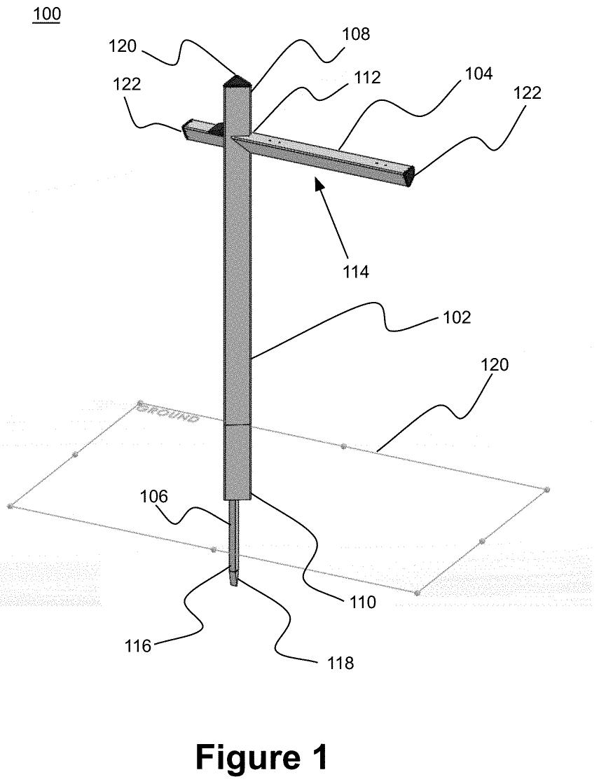

Turning now to FIG. 1, FIG. 1 illustrates a modular sign system, in accordance with various embodiments. In FIG. 1, a modular sign system (hereon sign 100) may include a first substantially triangular tube (hereon vertical tube 102), a second substantially triangular tube (hereon horizontal tube 104), and a stake 106. In FIG. 1, the vertical tube 102 may have a top end 108 and a bottom end 110. The vertical tube 102 may have a substantially triangular cutout (hereon cutout 112) proximate to the top end 108. The horizontal tube 104 may be configured to slide into the cutout 112 (i.e., horizontal tube 104 may have an outside dimension to substantially fit within the cutout 112. As shown in FIG. 1, the vertical tube 102 and the horizontal tube 104 may form substantially an offset cross shape, which may be recognizable as a real estate sign/lawn sign. A panel having information (not shown) may be hung or attached along a long portion 114 of the horizontal tube 104.

Shown in FIG. 1, the stake 106 may have a ground engaging end 116, where the ground engaging end 116 may have a pointed end 118. The ground engaging end 116 may be disposed within the ground 120 as shown.

Additionally, shown in FIG. 1, the top end 108 may include an end cap 120, where the end cap 108 may be utilized to cap off the exposed top end 108 of the vertical tube 102. The horizontal tube 104 may have end caps 122 at either end (i.e., exposed ends of the horizontal tube 104.

As described above in the non-limiting example and as will be further described, the sign 100 may comprise of various components that may be configured to facilitate easy transport and easy assembly resulting in sign as shown.

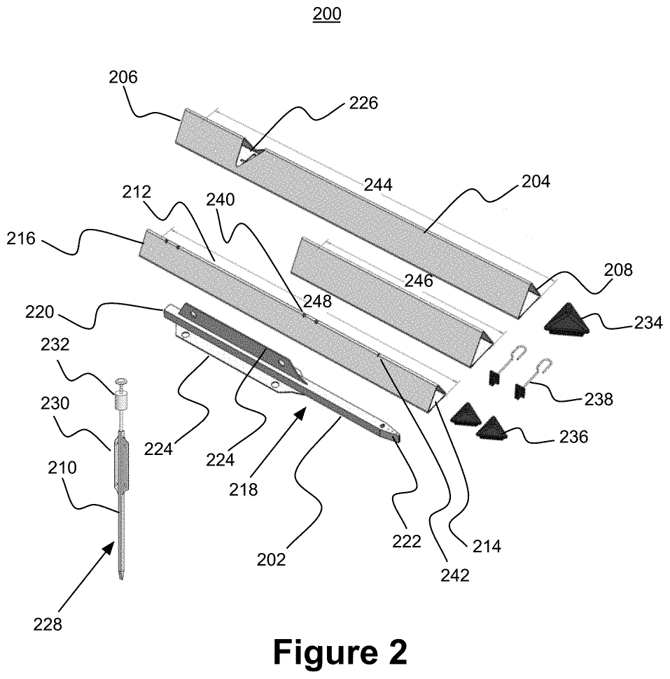

FIG. 2 illustrates a modular sign system with its components, in accordance with various embodiments. In FIG. 2, a modular sign system 200 may be similar to the modular sign system 100 shown in FIG. 1. However, the modular sign system 200 may have its components shown as separate components. Shown in FIG. 2, the modular system 200 may include a stake 202, a first substantial triangular tube (hereon vertical tube 204) having a top end 206 and a bottom end 208, a stake drive 210, and a second substantially triangular tube 212 having a first end 214 and a second end 216.

As shown, the stake 202 may have a tubular body 218, an open end 220 exposing a hole of the tubular body 218, and a ground engaging end 222. Additionally, the stake 202 may have a number of fins 224 along the length of the tubular body 218, where the fins 224 may form a substantially triangular shape as described above.

In FIG. 2, the vertical tube 204 may have internal dimensions to substantially match the triangular shape formed by the fins 224 on the stake 202. Additionally, the vertical tube 204 may have a substantially triangular cutout 226 located proximate to the top end 206 of the vertical tube 204 as shown. The horizontal tube 212 may have an outside dimension to substantially fit within the cutout 226 forming the sign 100 shown in FIG. 1.

In FIG. 2, the stake driver 210 may have a solid body 228 having a dimension to substantially fit within the open end 220 of the stake 202. Additionally, the stake driver 210 may include a weight 230 having a dimension larger than the solid body 228 of the stake driver 210. The weight 230 may be disposed at one end of the stake driver 210, where a handle 232 may be disposed proximate to the weight 230. As described herein, the stake driver 210 may be utilized to drive the stake 202 into the ground 120 (shown in FIG. 1).

Additionally, shown in FIG. 2, the modular sign system 200 may include an end cap 234 configured to substantially fit into the top end 206 of the vertical tube 204. The modular sign system 200 may include two end caps 236 configured to substantially fit into the first and second ends 214 & 216 of the horizontal tube 212. Further, the modular sign system 200 may include two hanging hooks 238, which may be configured to attach to the horizontal tube 212 at a panel attachment holes 240 on the horizontal tube 212.

As described above, the modular sign system 200 may have a tab 242 disposed at a predetermined distance from the first end 214 of the horizontal tube 212. The tab 242 may be configured to stop the horizontal tube 214 a predetermined distance into the cutout 226 on the vertical tube 204. The predetermined distance may correspond to substantially match the width of a panel for displaying information (not shown).

In FIG. 2, some non-limiting example dimensions may be shown such as, but not limited to approximately 44 inches 244, approximately 22 inches 246, and approximately 36 inches 248. It should be appreciated that these dimensions are only but non-limiting examples and can be a wide range of dimension. Accordingly, the claims subject matter is not limited in these respects.

As a result, the modular sign system 200 may be easily transportable as separate components, which may be easily assembled to form the sign 100 (shown in FIG. 1).

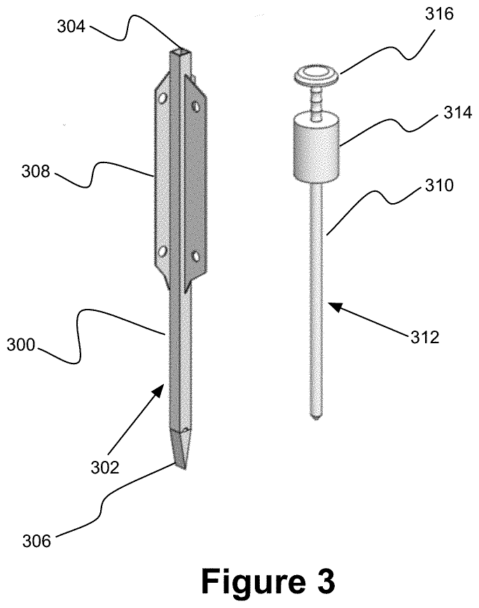

FIG. 3 illustrates a stake and stake driver utilized with a modular sign system, in accordance with various embodiments. In FIG. 3, a stake 300 may have a tubular body 302, an open end 304 exposing a hole of the tubular body 302, and a ground engaging end 306, where the ground engaging end 306 may have a point configured to penetrate a surface. Additionally, the stake 300 may have a number of fins 308 along the length of the tubular body 302, where the fins 308 may form a substantially triangular shape as described above.

Additionally, in FIG. 3, a stake driver 310 may have a solid body 312 having a dimension to substantially fit within the open end 304 of the stake 300. Additionally, the stake driver 310 may include a weight 314, which may have a dimension larger than the solid body 312 of the stake driver 310. The weight 314 may be disposed at one end of the stake driver 310, where a handle 316 may be disposed proximate to the weight 314. As described herein, the stake driver 310 may be inserted into the open end 304 of the stake 300. Once inserted, a person may move the stake driver 310 up and down and utilize the weight 314 to drive the stake 300 into a surface (e.g., ground 120 shown in FIG. 1). Subsequently, a vertical tube may be slid over the stake 302 as described throughout herein.

As a result, the modular sign system may facilitate at least ease of transportation as individual components (e.g., easy breakdown and easy assembly). Additionally, the modular sign system may at least facilitate ease of stake placement (e.g., integrated stake driver, which may facilitate driving in many ground conditions such as, but not limited to soil, sand gravel, wet, dry, frozen, etc.). Further the modular sign system may facilitate improved strength (e.g., the stake configured to support the vertical tube).

It should be appreciated after review of this disclosure that it is contemplated within the scope and spirit of the present disclosure that the claimed subject matter may include a wide variety of signs. Accordingly, the claimed subject matter is not limited in these respects.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter is not limited to the particular examples disclosed, but that such claimed subject matter also may include all implementations falling within the scope of the appended claims, and equivalents thereof.

What is claimed:

1. A real estate modular sign system comprising:
a first substantially triangular tube having a top end and a bottom end, the first substantially triangular tube having a substantially triangular cutout proximate to the top end; and
a second substantially triangular tube having a first end and a second end, the second substantially triangular tube having an outside dimension to substantially fit within the substantially triangular cutout of the first substantially triangular tube.

2. The real estate modular sign system of claim 1, wherein the substantially triangular cutout is configured to receive the second substantially triangular tube at a substantially right angle relative to the length of the first substantially triangular tube

3. The real estate modular sign system of claim 1 further comprising:
a stake, the stake having a tubular body, an open end exposing a hole of the tubular body, a ground engaging end opposite the open end, and a plurality of fins disposed along the length of the tubular body forming a substantially triangular shape; and
a stake driver, the stake driver having a solid body having a dimension to substantially fit within the open end of the stake, a weight having a dimension larger than the solid body disposed at one end of the stake driver, and a handle disposed proximate to the weight.

4. The real estate modular sign system of claim 3, wherein the stake comprises a substantially square tubular body.

5. The real estate modular sign system of claim 3, wherein the ground engaging end comprises a pointed end.

6. The real estate modular sign system of claim 3, wherein the plurality of fins are disposed at 120 degrees relative to each other along the length of the tubular body.

7. The real estate modular sign system of claim 3, wherein the bottom end of the first substantially triangular tube is configured to slide over the stake.

8. The real estate modular sign system of claim 3, wherein the stake is configured to support the first substantially triangular tube in a substantially vertical position.

9. The real estate modular sign system of claim 3, wherein the stake driver is configured to slidably drive the ground engaging end of the stake into the ground.

10. The real estate modular sign system of claim 1, wherein the second substantially triangular tube comprises a tab disposed at a predetermined distance from the first end, the tab configured to stop the second substantially triangular tube a predetermined distance into the substantially triangular cutout.

11. A modular sign system comprising:
a stake, the stake having a tubular body, an open end exposing a hole of the tubular body, a ground engaging end opposite the open end, and a plurality of fins disposed along the length of the tubular body forming a substantially triangular shape;
a first substantially triangular tube having a top end and a bottom end, the first substantially triangular tube having internal dimensions to substantially match the substantially triangular shape formed by the plurality of fins, and having a substantially triangular cutout proximate to the top end;
a stake driver, the stake driver having a solid body having a dimension to substantially fit within the open end of the stake, a weight having a dimension larger than the solid body disposed at one end of the stake driver, and a handle disposed proximate to the weight; and
a second substantially triangular tube having a first end and a second end, the second substantially triangular tube having an outside dimension to substantially fit within the substantially triangular cutout of the first substantially triangular tube.

12. The modular sign system of claim 11, wherein the stake comprises a substantially square tubular body.

13. The modular sign system of claim 11, wherein the ground engaging end comprises a pointed end.

14. The modular sign system of claim 11, wherein the plurality of fins are disposed at 120 degrees relative to each other along the length of the tubular body.

15. The modular sign system of claim 11, wherein the bottom end of the first substantially triangular tube is configured to slide over the stake.

16. The modular sign system of claim 15, wherein the stake is configured to support the first substantially triangular tube in a substantially vertical position.

17. The modular sign system of claim 11, wherein the substantially triangular cutout is configured to receive the second substantially triangular tube at a substantially right angle relative to the length of the first substantially triangular tube.

18. The modular sign system of claim 11, wherein the stake driver is configured to slidably drive the ground engaging end of the stake into the ground.

19. The modular sign system of claim 11, wherein the second substantially triangular tube comprises a tab disposed at a predetermined distance from the first end, the tab configured to stop the second substantially triangular tube a predetermined distance into the substantially triangular cutout.

20. The modular sign system of claim 19, wherein the first triangular tube in a substantially vertical position and the second triangular tube in a substantially horizontal position forms a sign holder configured to hang a sign.

21. A method of assembling a real estate sign comprising:
causing to dispose a stake into a ground, the stake having a tubular body, an open end exposing a hole of the tubular body, a ground engaging end opposite the open end, and a plurality of fins disposed along the length of the tubular body forming a shape;
disposing a stake driver into the tubular body of the stake at the open end, the stake driver having a solid body having a dimension to substantially fit within the open end of the stake, a weight having a dimension larger than the solid body disposed at one end of the stake driver, and a handle disposed proximate to the weight; and
causing to slide the stake driver in a substantially up and down motion along the length of the stake; and
sliding a vertical tube along the length of the stake, wherein the plurality of fins are configured to substantially match the shape of the vertical tube.
